(19) United States
(12) Patent Application Publication
(10) Pub. No.: US 2011/0273484 A1
(43) Pub. Date: Nov. 10, 2011

(54) METHOD FOR CONTROLLING THE DISPLAY CIRCUIT AND BACKLIGHT OF A DISPLAY DEVICE

(76) Inventors: Shih-Pin Chen, Taoyuan County (TW); Hsin-Nan Lin, New Taipei City (TW); Chi-Pao Huang, Taoyuan County (TW)

(21) Appl. No.: 13/100,308

(22) Filed: May 4, 2011

(30) Foreign Application Priority Data
May 4, 2010 (TW) 099114210
Jun. 3, 2010 (TW) 099117952

(51) Int. Cl. G09G 5/10

(52) U.S. Cl. 345/690

(57) ABSTRACT

A method for controlling the display circuit and the backlight source of a display device is utilized to improve the color display performance at the low grey scale region. The method includes dividing a plurality of display data into first original display data and second original display data according to a threshold value; the display circuit outputting the first original display data at a first frame duration; the backlight source outputting a first brightness at the first frame duration; the display circuit adjusting the second original display data according to a first parameter for generating second adjusted display data; the display circuit outputting the second adjusted display data at a second frame duration; lowering the first brightness according to the first parameter for generating a second brightness; and the backlight source outputting the second brightness at the second frame duration.

### BACKGROUND OF THE INVENTION

1. Field of the Invention

The present invention is related to a method for controlling display circuit and backlight of a display device, and more particularly, to a method for adjusting display data received by the display circuit according to a parameter and adjusting the backlight accordingly, for improving color display performance of display panel of the display device in a low grey scale region.

2. Description of the Prior Art

Please refer to FIG. 1. FIG. 1 is a diagram illustrating a color temperature curve of a conventional display panel. The color temperature curve illustrates color temperature performance of the conventional display panel in different grey scales.

The curvature of the color temperature curve of an ideal display device should be as close to flat (e.g. around 6500K) as possible, meaning the display device should also attain similar color temperature performance in different grey scales for viewers to perceive consistent color display performance. However, as shown in FIG. 1, the color temperature curve of the conventional display panel in low grey scale region is clearly inconsistent, and appears to be a nonlinear curve. Generally, the nonlinear color temperature curve appears in lower grey scale region, which is around one eighth of 256 grey scales, i.e. around grey scales 0-31. The nonlinearity is especially distinct for TN (Twisted Nematic) display panels. In other words, the conventional display panel suffers from inaccurate display color temperature in low grey scale region, causing the display panel to display inaccurate color tone when displaying low grey scale images, consequently decreasing display quality of the display panel.

### SUMMARY OF THE INVENTION

The present invention discloses a method for controlling a display circuit and a backlight of a display device. The method comprises receiving a plurality of display data groups for driving a plurality of display units of same color within the backlight by the display circuit; categorizing the display data groups into a first original display data in a first interval and a second original display data in a second interval, wherein numerical values in the first original display data are larger than or equal to a threshold value, and the other numerical values in the second original display data are smaller than the threshold value; outputting the first original display data in a first frame duration by the display circuit; outputting a first brightness in the first frame duration and sustaining the first brightness for a first lighting duration by the backlight; adjusting the second original display data for generating second adjusted display data according to a first parameter G1, wherein light transmittance corresponding to the second adjusted display data is higher than light transmittance corresponding to the second original display data; outputting the second adjusted display data in a second frame duration by the display circuit; and adjusting output of the backlight of the display device according to the first parameter G1 in the second frame duration.

The present invention further discloses a method of controlling a display circuit and a backlight of a display device. The method comprises receiving a plurality of display data groups for driving a plurality of display units of same color within the backlight by the display circuit; categorizing the display data groups into first original display data in a first interval, second original display data in a second interval, and third original display data in a third interval, wherein numerical values of the first original display data are larger than or equal to a first threshold value, numerical values of the second original display data are smaller than the first threshold value and larger than or equal to a second threshold value, and numerical values of the third original display data are smaller than the second threshold value; outputting the first original display data in a first frame duration by the display circuit; outputting a first brightness in the first frame duration and sustaining the first brightness for a first lighting duration by the backlight; adjusting the second original display data for generating second adjusted display data according to a first parameter G1; outputting the second adjusted display data in a second frame duration by the display circuit; adjusting the first lighting duration for generating a second lighting duration according to the first parameter G1, and adjusting the first brightness for generating a second brightness, wherein a product of the second brightness and the second lighting duration is smaller than a product of the first brightness and the first lighting duration; outputting the second brightness in the second frame duration and sustaining the second brightness for the second lighting duration by the backlight; adjusting the third original display data for generating third adjusted display data according to the first parameter G1 and a second parameter G2; outputting the third adjusted display data in a third frame duration by the display circuit; adjusting the second brightness for generating a third brightness according to the second parameter G2, and adjusting the second lighting duration for generating a third lighting duration, wherein a product of the third brightness and the third lighting duration is smaller than a product of the second brightness and the second lighting duration; and outputting the third brightness in the third frame duration and sustaining the third brightness for the third lighting duration by the backlight.

The present invention further discloses a method for controlling a first color backlight and a second color backlight of a display circuit of a display device. The method comprises receiving a plurality of first display data groups for driving a plurality of display units of the first color backlight by the display circuit; categorizing the first display data groups into first color first original display data in a first interval and first color second original display data in a second interval, wherein numerical values of the first color first original display data are larger than or equal to a first threshold value, and numerical values of the first color second original display data are smaller than the first threshold value; receiving a plurality of second display data groups for driving a plurality of display units of the second color backlight by the display circuit; categorizing the second display data groups into second color first original display data in a third interval and second color second original display data in a fourth interval, wherein numerical values of the second color first original display data are greater than or equal to a second threshold value, and numerical values of the second color second original display data are smaller than the second threshold value; outputting the first color first original display data in a first frame duration by the display circuit; outputting a first brightness in the first frame duration and sustaining the first brightness for a first lighting duration by the first color backlight; adjusting the first color second original display data for generating first color second adjusted display data according to a first parameter G1, wherein light transmittance corresponding to the first color second adjusted display data is higher than light transmittance corresponding to the first color second original display data; outputting the first color second adjusted display data in a second frame duration by the display circuit; adjusting the first brightness for generating a second brightness according to the first parameter G1, and adjusting the first lighting duration to generate a second lighting duration, wherein a product of the second brightness and the second lighting duration is smaller than a product of the first brightness and the first lighting duration; outputting the second brightness in the second frame duration and sustaining the second brightness for the second lighting duration by the first color backlight; outputting the second color first original display data in a third frame duration by the display circuit; outputting a third brightness in the third frame duration and sustaining the third brightness for a third lighting duration by the second color backlight; adjusting the second color second original display data for generating second color second adjusted display data according to a second parameter G2, wherein light transmittance corresponding to the second color second adjusted display data is higher than light transmittance corresponding to the second color second original display data; outputting the second color second adjusted display data in a fourth frame duration by the display circuit; adjusting the third brightness for generating a fourth brightness according to the second parameter G2, and adjusting the third lighting duration for generating a fourth lighting duration, wherein a product of the fourth brightness and the fourth lighting duration is smaller than a product of the third brightness and the third lighting duration; and outputting the fourth brightness in the fourth frame duration and sustaining the fourth brightness for the fourth lighting duration by the second color backlight.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a color temperature curve of a conventional display panel.

FIG. 2A-2D are a flow chart illustrating a first embodiment of a method of the present invention for controlling display circuit and backlight of a display device.

FIG. 3A is a diagram illustrating an example of the flow chart of the first embodiment in FIG. 2A and FIG. 2B.

FIG. 3B is a diagram illustrating an example of the flow chart of the first embodiment in which steps 208-210 in FIG. 2A and FIG. 2B are combined with steps 211-212b in FIG. 2C.

FIG. 3C is a diagram illustrating an example of the flow chart of the first embodiment in which steps 208-210 in FIG. 2A and FIG. 2B are combined with steps 211-212c in FIG. 2D.

FIG. 4A and FIG. 4B are a flow chart illustrating a second embodiment of a method of the present invention for controlling display circuit and backlight of a display device.

FIG. 5 is a diagram illustrating an example of the flow chart of the second embodiment in FIG. 4A and FIG. 4B.

FIG. 6 is a diagram illustrating a third embodiment of the method of the present invention for controlling display circuit and backlight of a display device.

FIG. 7 is a diagram illustrating a control device of the present invention.

FIG. 8 is a diagram illustrating a color temperature curve of a display panel utilizing the control method of the present invention.

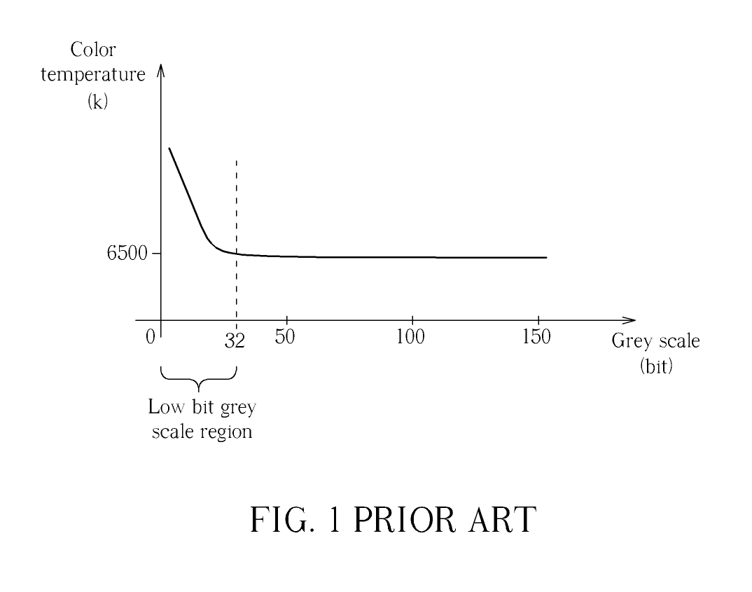

### DETAILED DESCRIPTION

The highest resolution for a liquid crystal display (LCD) panel to display images depends on a number of pixels of the display panel. For instance, if the display panel comprises 1920*1080 pixels, the display panel can display an input image signal with full HD (high definition) resolution of up to 1920*1080 without distortion. Generally a pixel comprises at least three sub-pixels, which correspond to primary colors of red, green and blue (RGB) respectively. This way, the three sub-pixels can be combined to provide the pixel with full color display capability.

Due to visual persistent effect, color intensity of primary colors displayed by sub-pixels of the LCD panel that is perceivable by human eyes within a short duration, such as 16 milliseconds, can be represented by the following formula:

Color display of a pixel=light transmittance of sub-pixels on the display panel*backlight brightness*lighting duration . . . (1)

where the lighting duration corresponds to duration when a sub-pixel is driven for the light to pass through with the backlight turned on. The light transmittance of the pixel of the display panel corresponds to grey scale data of an input image signal received externally. By processing high bit display data (e.g. high grey scale) and low bit display data (e.g. low grey scale) separately, adjusting the low bit display data according to a parameter (e.g. first parameter G1) and accordingly adjusting the backlight brightness or the lighting duration at the same time, the present invention is able to improve the nonlinear color temperature performance at the low grey scale region for the display panel.

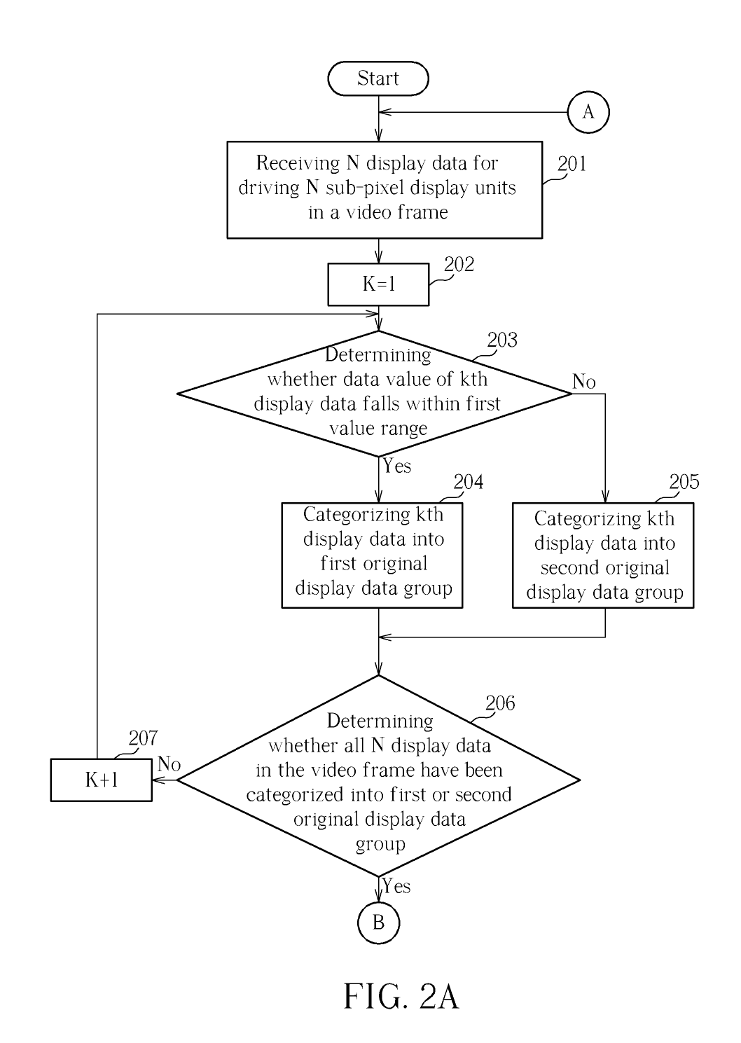

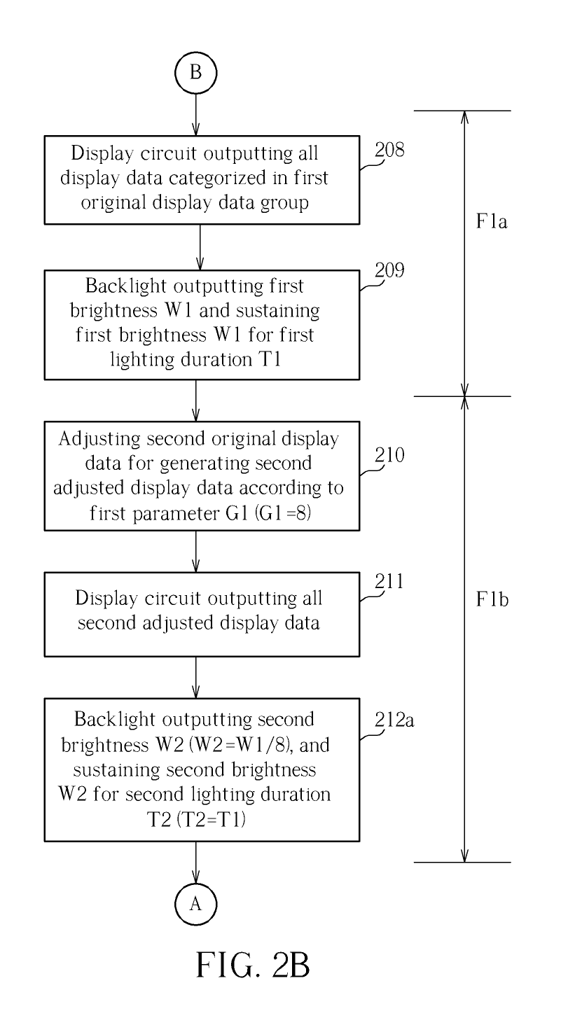

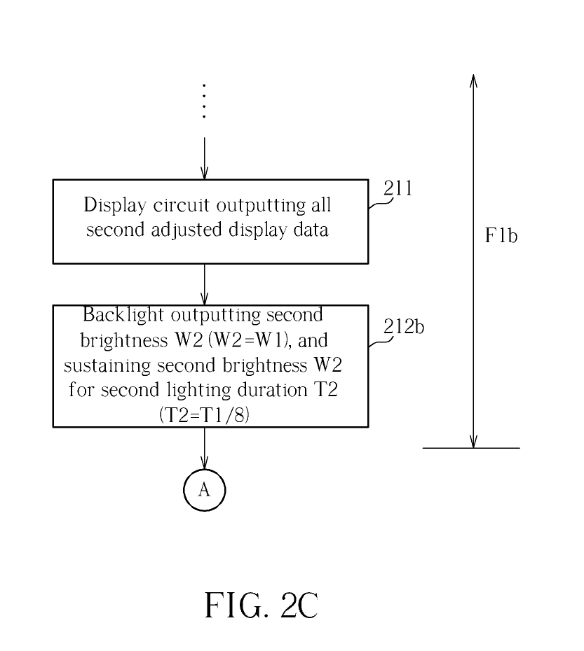

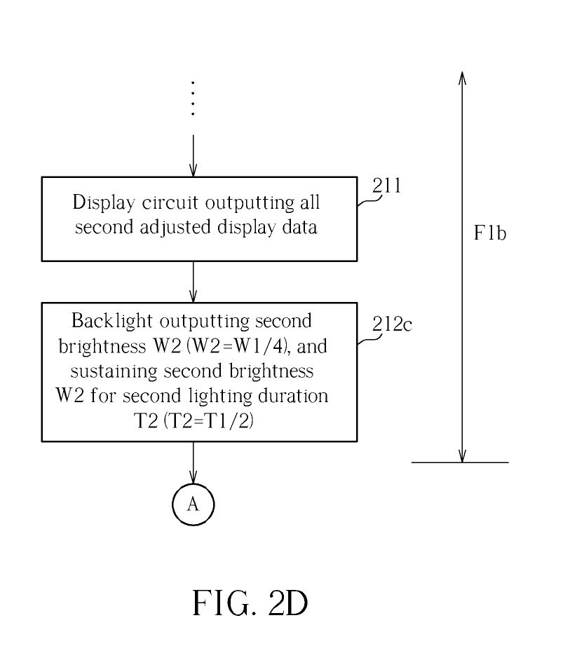

Please refer to FIG. 2A and FIG. 2B together. FIG. 2A and FIG. 2B are a flow chart illustrating a first embodiment of a method of the present invention for controlling a display circuit and backlight of a display device. A plurality of display data groups, which are for driving a plurality of display units of the same color, are received by the display circuit. The display data groups are categorized into first original display data of a first interval and second original display data of a second interval. Numerical values of the first original display data are larger than or equal to a threshold value, and numerical values of the second original display data are smaller than the threshold value. The second original display data is M bits long, and ranges from 0 to 2^{N}−1, the first parameter G1 is 2^{N}, and the threshold value is 2^{M-N}. For instance, in the first embodiment, the first and second original display data are both 8 bits long, where values of the first original display data range from 32 to 255, values of the second original display data range from 0 to 31, the first parameter G1 is 2³=8, and the threshold value is set to 2⁸⁻³=32. The display data is compared to the threshold value (e.g. 32), and the display data is categorized into a first original display data group of high bit data (e.g. high grey scale), and a second original display data group of low bit data (e.g. low grey scale). Display data of the second original display data group is then adjusted according to the first parameter G1, and the backlight brightness or the lighting duration is accordingly adjusted at the same time. The steps of the method of the present invention are described below:

Step 201: receiving N display data for driving N sub-pixel display units in a video frame;

Step 202: setting a counter K (e.g. K is from 1 to N);

Step 203: determining whether data value of the kth display data falls within a first interval; if so, proceed to step 204, otherwise proceed to step 205;

Step 204: categorizing the kth display data into the first original display data group, and proceeding to step 206;

Step 205: categorizing the kth display data into the second original display data group, and proceeding to step 206;

Step 206: determining whether all N display data in the video frame have been categorized into the first or second original display data group; if so (e.g. K=N), proceed to step 208, otherwise proceed to step 207;

Step 207: incrementing the counter K by 1;

Step 208: the display circuit outputting all display data categorized in the first original display data group for the corresponding sub-pixel display unit to output images corresponding to the first original display data group;

Step 209: the backlight outputting a first brightness W1 and sustaining the first brightness W1 for a first lighting duration T1;

Step 210: adjusting second original display data (i.e. display data of the second original display data group) for generating second adjusted display data according to the first parameter G1, light transmittance when the display unit is driven by the second adjusted display data being higher than light transmittance when the display unit is driven by the second original display data; in the present embodiment, the value of each display data of the second original display data group is multiplied by the first parameter G1 for generating the second adjusted display data, and the light transmittance corresponding to the second adjusted display data is G1 times the light transmittance corresponding to the second original display data;

Step 211: the display circuit outputting all second adjusted display data for the corresponding sub-pixel driving units to output images corresponding to the second adjusted display data; and

Step 212a: the backlight outputting a second brightness W2, and sustaining the second brightness W2 for a second lighting duration T2 (e.g. T2=T1), the second brightness W2 being generated by dividing the first brightness W1 by the first parameter G1; proceed to step 201, for receiving and processing N display data of a next video frame.

In step 201, display units are sub-pixels for displaying primary colors of red, green and blue. Since a nonlinear color temperature curve generally appears in lower grey scales 0-31, in step 203 of the present invention, a threshold value is set to 32 for defining the first interval to be grey scales 32-255. In step 204, the kth display data falling in the first interval (e.g. grey scales 32-255) is categorized into the first original display data group, so the first original display data group comprises high bit display data. In step 205, the kth display data not in the first interval (e.g. grey scales 0-31) is categorized into the second original display data group, so the second original display data group comprises low bit display data. In step 206, when N display data of the video frame have not been fully categorized into the first and second original display data groups, steps 201-207 are repeated until all display data in the video frame have been categorized.

In steps 208 and 209, the display circuit outputs display data of the first original display data group, and the backlight outputs first brightness W1 and sustains the first brightness W1 for the first lighting duration T1; first brightness W1, first lighting duration T1 and display data of the first original display data group are unadjusted.

In step 210, display data (e.g. data which is in between grey scales 0-31) of the second original display data group is adjusted according to the first parameter G1. Since a nonlinear color temperature curve appears in a lower grey scale region of around one eighth of the 256 grey scales, the first parameter G1 is set to 8 in the present embodiment. This way, each display data of the second original display data group is multiplied by 8 to generate the second adjusted display data. For instance, if one display data of the second original display data group corresponding to a certain sub-pixel is 31, then the second adjusted display data corresponding to the certain sub-pixel is 248 (i.e. 31*8=248); if one display data of the second original display data group corresponding to a certain sub-pixel is 20, then the second adjusted display data corresponding to the certain sub-pixel is 160 (i.e. 20*8=160). Accordingly, grey scale variation of the second adjusted display data is scaled up to a range of grey scales 0-248. In other words, display data of the second original display data group is adjusted according to the first parameter G1, for “light transmittance corresponding to the second adjusted display data” to be higher than “light transmittance corresponding to the second original display data”. This way, regions where the linear color temperature curve appears in the LCD device are utilized as much as possible to present the second adjusted display data. When each display data of the second original display data group is multiplied by 8, “light transmittance corresponding to the second adjusted display data” is about eight times “light transmittance corresponding to the second original display data”.

According to formula (1), for human eyes to perceive grey scales 0-31 of the original display data, the first brightness W1 or the first lighting duration T1 is divided by the first parameter G1 after the display data is multiplied by the first parameter G1, and it is for outputting color display corresponding to the original display data.

For instance, if the original first lighting duration T1 is sustained (e.g. second lighting duration T2=T1) in a second frame duration F1b, then the first brightness W1 is divided by 8 correspondingly to generate a first brightness W2 (e.g. W2=W1/8), as shown in step 212a.

If the first brightness W1 is sustained in the second frame duration F1b, then the first lighting duration T1 is divided by the first parameter G1 correspondingly to generate a second lighting duration T2 (e.g. T2=T1/8) in the second frame duration F1b, as shown in step 212b of FIG. 2C.

According to formula (1), the backlight brightness W1 and the original first lighting duration T1 can also be adjusted together, to compensate for the effect of multiplying the original display data by the first parameter G1 (e.g. G1=8). In other words, “reducing the first lighting duration T1 to generate a second lighting duration T2” and “reducing the first brightness W1 to generate a second brightness W2” can be carried out together according to the first parameter G1, for a product of second brightness W2 and second lighting duration T2 to be less than a product of first brightness W1 and first lighting duration T1. For instance, the first lighting duration T1 may be divided by X for the second lighting duration T2 of the backlight to be (1/X) times the first lighting duration T1, and the brightness of the backlight may be reduced to (1/Y) times for reducing the second brightness W2 of the backlight to be (1/Y) of the first brightness W1, where the first parameter G1=X*Y. Referring to step 212c of FIG. 2D, the second brightness W2 is (¼) of the first brightness W1 (i.e. W2=W1/4), and at the same time, the second lighting duration T2 is (½) of the first lighting duration T1 (i.e. T2=T1/2), so human eyes can perceive the grey scales (e.g. grey scales 0-31) of the original display data. Other steps 208-211 of FIGS. 2C and 2D are similar to those of FIG. 2B.

More specifically, since the second original display data group comprises low bit display data (e.g. grey scales 0-31), grey scale variation of the second adjusted display data obtained by multiplying each display data of the second original display data group by the first parameter G1 is scaled up by 8 times, e.g. grey scales 0-248, in the present embodiment. As mentioned above, the nonlinear color temperature curve of an LCD panel generally appears in lower grey scale region of around grey scales 0-31, so when the second adjusted display data is outputted to display images in step 210a, the nonlinear color temperature curve appears in lower grey scale region of grey scales 0-31 of the second adjusted display data, which correspond to a range of grey scales 0-3 (i.e. 31/8=3.875, which is rounded to 3 since digital signals are represented by positive integers) of the second original display data.

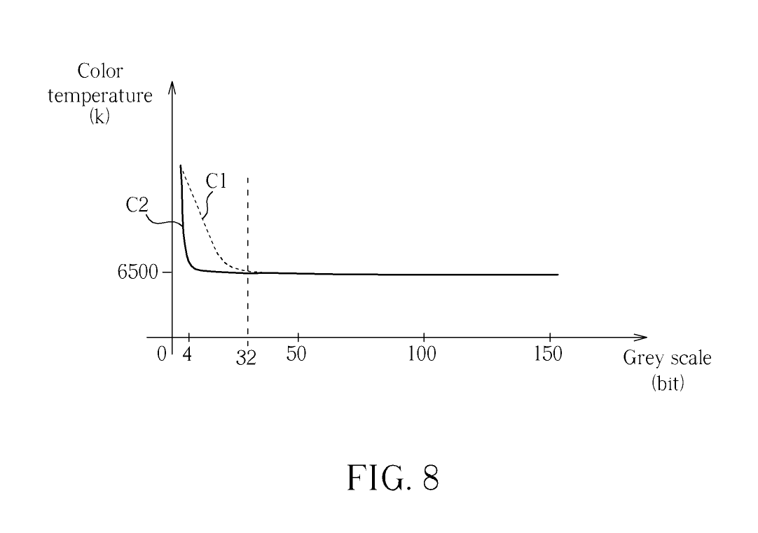

In other words, by utilizing the method of the present invention, the nonlinear color temperature curve can be reduced from appearing in a range of grey scales 0-31 to 0-3 of the original display data, consequently reducing distribution of inaccurate color display when the display panel displays low grey scales, further improving image quality. Please refer to FIG. 8. FIG. 8 is a diagram illustrating a color temperature curve of a display panel utilizing the control method of the present invention. Temperature curve C2 generated according to the present invention appears in a region of even lower grey scales (e.g. grey scales 0-3) compared to temperature curve C1 of the prior art, meaning temperature curve C2 is closer to flat, and inaccurate color display when the display panel displays low grey scales can be improved.

This way, N original display data of N sub-pixels corresponding to one single video frame complete output via steps 208-212; unadjusted first brightness W1 and unadjusted display data of the first original display data group are outputted in the first frame duration F1a in steps 208-209; and second brightness W2 and second adjusted display data are outputted in the second frame duration F1b in steps 210-212.

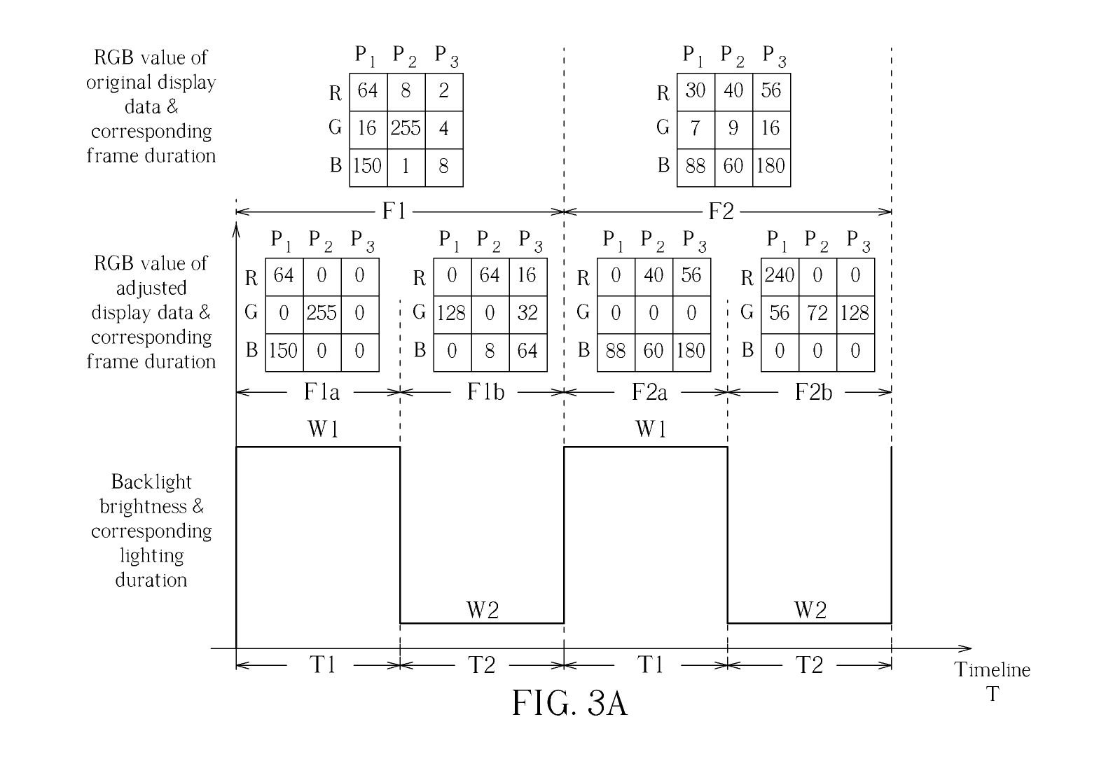

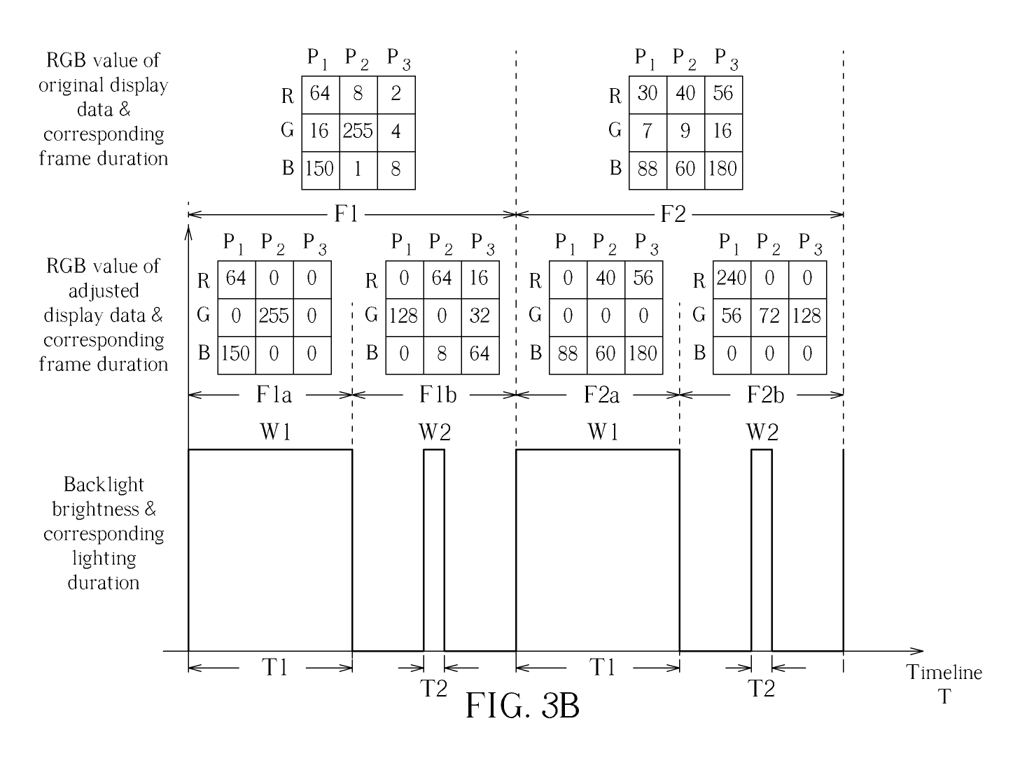

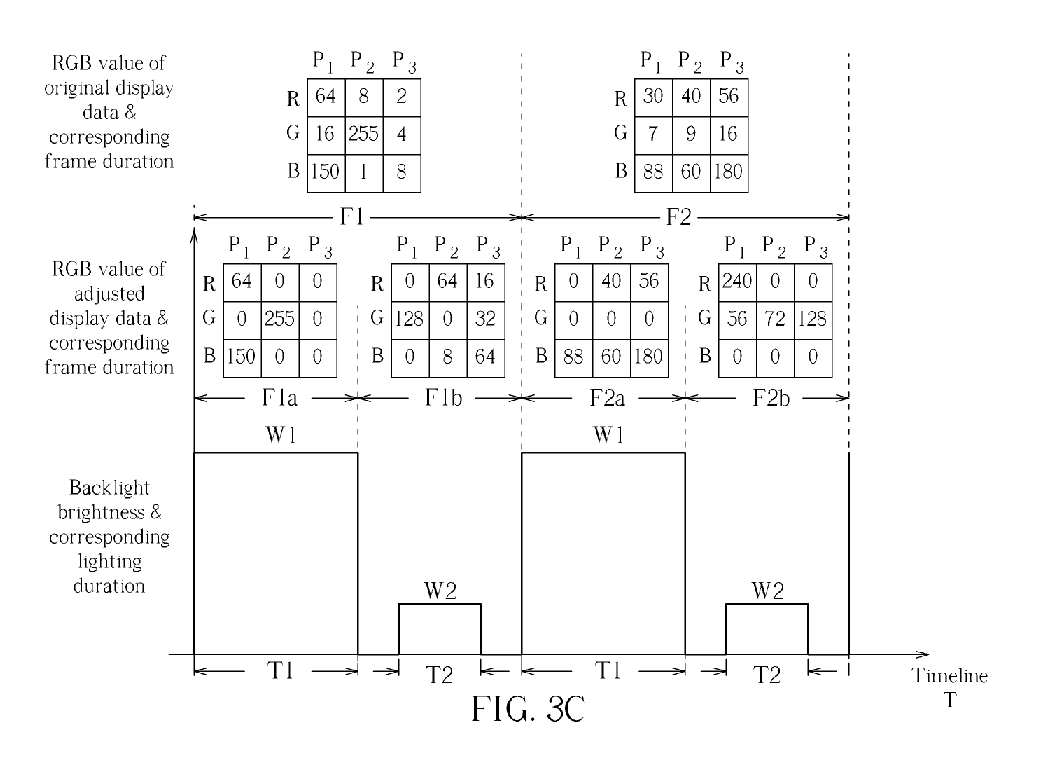

Please refer to FIG. 3A. FIG. 3A is a diagram illustrating an example of the flow chart of the first embodiment in FIG. 2A and FIG. 2B. As shown in FIG. 3A, in a first original frame F1, the display device receives display data of three pixels P1, P2 and P3. Values of sub-pixels (R, G, B) of pixels P1, P2 and P3 are (64, 16, 150), (8, 255, 1), (2, 4, 8) respectively. Assuming a first threshold value is 32, a first interval is 32-255, and a first parameter G1 is 8; display data falling within the first interval is categorized into the first original display data group, and display data that does not fall within the first interval is categorized into the second original display data group.

In a first frame duration F1a of a first original frame F1, the display circuit outputs all display data categorized in the first original display data group; and in a first lighting duration T1 of the first original frame F1, the backlight displays 100% backlight brightness. Therefore, values of sub-pixels (R, G, B) of pixels P1, P2 and P3 are (64, 0, 150), (0, 255, 0), (0, 0, 0) respectively in the first frame duration F1a.

In a second frame duration F1b of the first original frame F1, the display circuit multiplies all display data of the second original display data group by the first parameter G1 and outputs the multiplied display data of the second original display data group; and in a second lighting duration T2 of the first original frame F1, the backlight adjusts backlight brightness according to the first parameter G1 and displays 12.5% (e.g. 100%/8=12.5%) backlight brightness. The second lighting duration T2 is sustained to equal the first lighting duration T1. Therefore, values of sub-pixels (R, G, B) of pixels P1, P2 and P3 are (0, 128, 0), (64, 0, 8), (16, 32, 64) respectively in the second frame duration F1b.

Each of the first and second frame durations F1a and F1b occupies 50% duration of the first original frame F1. Generally, frame rate of an LCD panel is 60 Hz, so the first original frame F1 is approximately 16 milliseconds, meaning each of the first and second frame durations F1a and F1b is around 8 milliseconds. Since the second lighting duration T2 is unadjusted, the first lighting duration T1 equals the second lighting duration T2. The first and second lighting durations T1, T2 correspond to the first and second frame durations F1a, F1b respectively.

In the second original frame F2, steps 201-212a are repeated. In the second original frame F2, the display device receives display data of three pixels P1, P2 and P3. Values of sub-pixels (R, G, B) of pixels P1, P2 and P3 are (30, 7, 88), (40, 9, 60), (56, 16, 180) respectively. The first threshold, first interval and the first parameter G1 are all similar to those of the first original frame F1.

In a first frame duration F2a of the second original frame F2, the display circuit outputs all display data categorized in the first original display data group; and in a first lighting duration T1 of the second original frame F2, the backlight displays 100% backlight brightness. Therefore, values of sub-pixels (R, G, B) of pixels P1, P2 and P3 are (0, 0, 88), (40, 0, 60), (56, 0, 180) respectively in the first frame duration F2a.

In a second frame duration F2b of the second original frame F2, the display circuit multiplies all display data of the second original display data group by the first parameter G1 and outputs multiplied display data of the second original display data group; and in a second lighting duration T2 of the second original frame F2, the backlight adjusts backlight brightness according to the first parameter G1 and displays 12.5% (e.g. 100%/8=12.5%) backlight brightness. The second lighting duration T2 is sustained to equal the first lighting duration T1. Therefore, values of sub-pixels (R, G, B) of pixels P1, P2 and P3 are (240, 56, 0), (0, 72, 0), (0, 128, 0) respectively in the second frame duration F2b.

The first and second frame durations F2a, F2b of the second original frame F2 are similar to the first and second frame durations F1a, F1b of the first original frame F1. Hence, each of the first and second frame durations F2a, F2b of the second original frame F2 is also around 8 milliseconds. The first and second lighting durations T1, T2 of the second original frame F2 are similar to the first and second lighting durations T1, T2 of the first original frame F1, so the first and second lighting durations T1, T2 of the second original frame F2 also correspond to the first and second frame durations F2a, F2b of the second original frame F2.

Please refer to FIG. 3B. FIG. 3B is a diagram illustrating an example of the flow chart of the first embodiment in which steps 208-210 in FIG. 2A and FIG. 2B are combined with steps 211-212b in FIG. 2C. In FIG. 3B, values of sub-pixels (R, G, B) of pixels P1, P2 and P3 received by the display device in the first and second original video frames F1, F2, the first threshold value, and the first parameter G1 are similar to those of FIG. 3A. The difference is that the first lighting duration T1 is divided by the first parameter G1 for generating the second lighting duration T2 (i.e. T2=T1/8), and the backlight sustains the original backlight brightness (i.e. 100%) in the second lighting duration T2.

Please refer to FIG. 3C. FIG. 3C is a diagram illustrating an example of the flow chart of the first embodiment in which steps 208-210 in FIG. 2A and FIG. 2B are combined with steps 211-212c in FIG. 2D. In FIG. 3C, values of sub-pixels (R, G, B) of pixels P1, P2 and P3 received by the display device in the first and second original video frames F1, F2, the first threshold value, and the first parameter G1 are similar to those of FIG. 3A. The difference is that the first lighting duration T2 is divided by 2 to generate the second lighting duration T2 (i.e. T2=T1/2), and the backlight brightness is ¼ (100%/4=25%) of the backlight brightness in the first frame duration F1a. This way, the product of “reduction ratio of lighting duration=2” and “reduction ratio of backlight brightness=4” equals the first parameter G1 (i.e. 8).

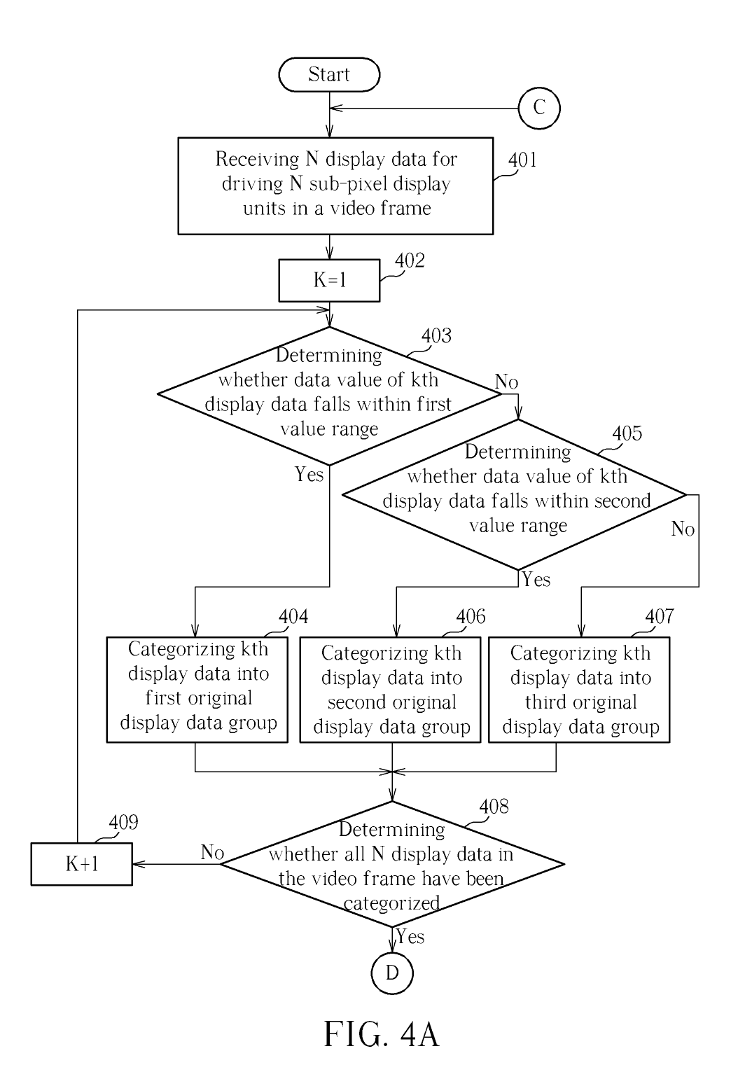

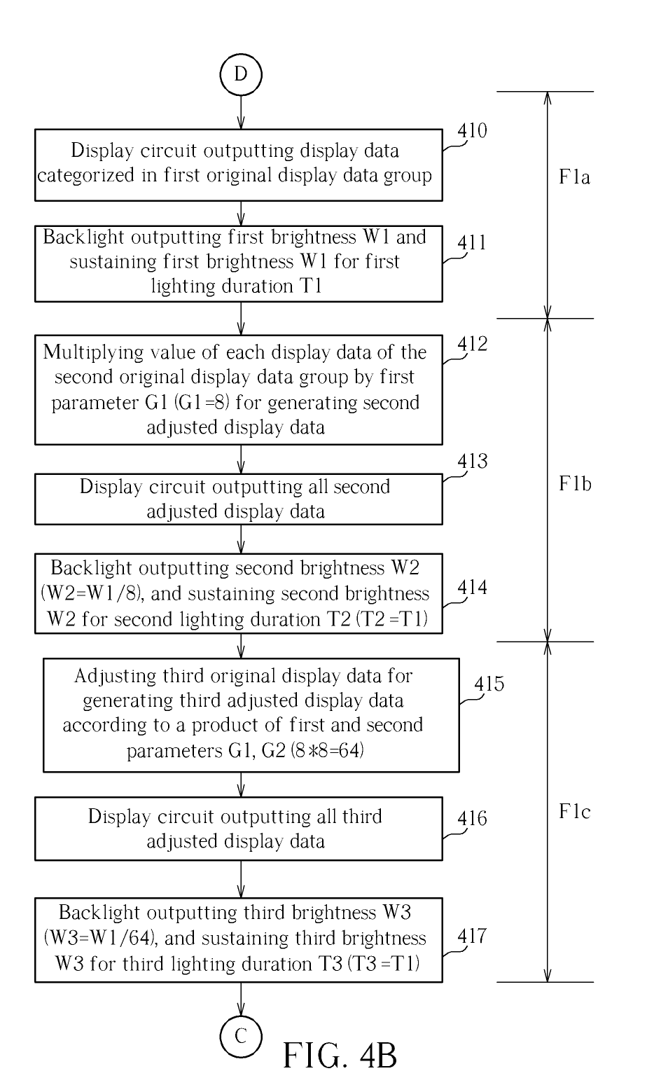

Please refer to FIG. 4A and FIG. 4B together. FIG. 4A and FIG. 4B are a flow chart illustrating a second embodiment of a method of the present invention for controlling a display circuit and backlight of a display device. In the second embodiment, the display data is categorized into a first original display data group, a second original display data group and a third original display data group. Display data of the second and third original display data groups are adjusted according to two parameters (e.g. first parameter G1 and second parameter G2) respectively at the same time. Backlight brightness or lighting duration is accordingly adjusted. For instance, a plurality of display data, which are for driving a plurality of display units of the same color, are received by the display circuit. The display data is categorized into first original display data of a first interval, second original display data of a second interval and third original display data of a third interval. Values of the first original display data of the first interval are larger than or equal to a first threshold value. Values of the second original display data of the second interval are smaller than the first threshold value but larger than or equal to a second threshold value. Values of the third original display data are smaller than the second threshold value. The steps of the method of the present invention are described below:

Step 401: receiving N display data for driving N sub-pixel display units in a video frame;

Step 402: setting a counter K (e.g. K is from 1 to N);

Step 403: determining whether data value of a kth display data falls within the first interval; if so, proceed to step 404, otherwise proceed to step 405;

Step 404: categorizing the kth display data into the first original display data group, and proceeding to step 408;

Step 405: determining whether data value of the kth display data falls within the second interval; if so, proceed to step 406, otherwise proceed to step 407;

Step 406: categorizing the kth display data into the second original display data group, and proceeding to step 408;

Step 407: categorizing the kth display data into the third original display data group, and proceeding to step 408;

Step 408: determining whether all N display data in the video frame have been categorized into the first, second or third original display data group; if so (e.g. K=N), proceed to step 410, otherwise proceed to step 409;

Step 409: incrementing the counter by 1;

Step 410: the display circuit outputting display data categorized in the first original display data group;

Step 411: the backlight outputting a first brightness W1 and sustaining the first brightness W1 for a first lighting duration T1;

Step 412: adjusting the second original display data for generating second adjusted display data according to the first parameter G1, for instance, value of each display data of the second original display data group being multiplied by the first parameter G1 for generating the second adjusted display data;

Step 413: the display circuit outputting all second adjusted display data;

Step 414: the backlight outputting a second brightness W2, and sustaining the second brightness W2 for a second lighting duration T2 (i.e. T2=T1), the second brightness W2 being generated by dividing the first brightness W1 by the first parameter G1. For human eyes to perceive grey scales of the original display data (e.g. grey scales 4-31 in the present embodiment), relation of the first parameter G1=(first brightness W1/second brightness W2)*(first lighting duration T1/second lighting duration T2) needs to be satisfied. For instance, if the first parameter G1=8, and (first brightness W1/second brightness W2)=1, then (first lighting duration T1/second lighting duration T2)=8;

Step 415: adjusting the third original display data for generating third adjusted display data according to a product of the first and second parameters G1, G2, for instance, value of each display data of the third original display data group being multiplied by the first parameter G1 first, then multiplied by the second parameter G2 (the first and second parameters G1, G2 are both set to 8 in the present embodiment) for generating the third adjusted display data;

Step 416: the display circuit outputting all third adjusted display data; and

Step 417: the backlight outputting a third brightness W3, and sustaining the third brightness W3 for a third lighting duration T3. For human eyes to perceive grey scales of the original display data (e.g. grey scales 0-3 in the present embodiment), relation of the second parameter G2=(second brightness W2/third brightness W3)*(second lighting duration T2/third lighting duration T3) needs to be satisfied; hence, the relation of (first parameter G1*second parameter G2)=(first brightness W1/third brightness W3)*(first lighting duration T1/third lighting duration T3). For instance, if the second parameter G2=8, and (second brightness W2/third brightness W3)=8, then (second lighting duration T2/third lighting duration T3)=1; proceed to step 401.

In the second embodiment, the first threshold value is 32 (i.e. 256/8=32) and the second threshold value is 4 (i.e. 32/8=4) for defining the first, second and third interval to be grey scales 32-255, 4-31 and 0-3 respectively. Steps 403-408 are repeated, e.g. display data is categorized into the first, second or third intervals, until all display data in the frame F1 have been categorized. In steps 410 and 411, the display circuit outputs all display data of the first original display data group, and the backlight outputs the first brightness W1 and sustains the first brightness W1 for the first lighting duration T1.

The principle of adjusting the second brightness W2, the third brightness W3, the second lighting duration T2, and the third light duration T3 is similar to the first embodiment (e.g. steps 212a, 212b and 212c) of the present invention, so relative descriptions are omitted. The condition of “second and third lighting durations T2, T3 are equal to the first lighting duration T1” is utilized to explain the second embodiment.

The first brightness W1 and display data of the first original display data group are unadjusted. In steps 412-414, the second brightness W2 and display data of the second original display data group (i.e. grey scales 4-31) are adjusted according to the first parameter G1. The first parameter G1 is 8, for instance. Display data of the second original display data group is multiplied by 8 to generate the second adjusted display data, meaning a grey scale variation range of the second adjusted display data is 32-248. The first brightness W1 is divided by 8 accordingly to generate the second brightness W2 (i.e. W2=W1/8).

In steps 415-417, the third brightness W3 and display data of the third original display data group (e.g. grey scales 0-3) are adjusted according to a product of the first and second parameters G1, G2. The first and second parameters G1, G2 are both 8 in the present embodiment. Display data of the third original display data group is multiplied by 64 to generate the third adjusted display data, meaning a grey scale variation range of the third adjusted display data is 0-192. The first brightness W1 is divided by 64 accordingly to generate the third brightness W3 (i.e. W3=W1/64).

In the first embodiment, one threshold value is utilized to categorize the original display data into first and second intervals. Display data of the second interval is adjusted according to the first parameter G1, and the backlight brightness or lighting duration is adjusted accordingly. The nonlinear color temperature curve can be reduced from a range of grey scales 0-31 to 0-3 of the original display data. In the second embodiment, two threshold values are utilized to categorize the original display data into first, second and third intervals. Display data of the second interval is adjusted according to the first parameter G1; display data of the third interval is adjusted according to the product of the first and second parameters G1, G2; and the backlight brightness or lighting duration is adjusted accordingly at the same time. This way the nonlinear color temperature curve can be further reduced from appearing in a range of grey scales 0-3 to 0 (31/64=0.48, which is rounded to 0 since digital signals are represented by positive integers).

Display data of the first original display data group and the unadjusted first brightness W1 are outputted in the first frame duration F1a in steps 410-411; second adjusted display data and the second brightness W2 are outputted in the second frame duration F1b in steps 412-414; third adjusted display data and the third brightness W3 are outputted in the third frame duration F1c in steps 415-417.

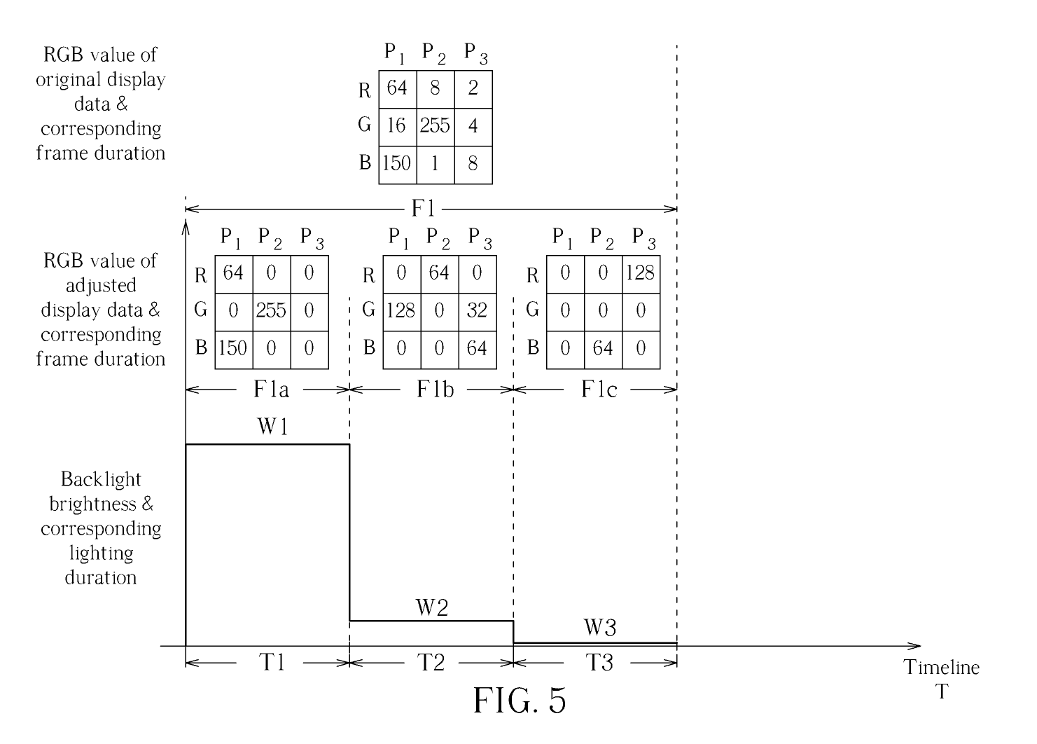

Please refer to FIG. 5. FIG. 5 is a diagram illustrating an example of the flow chart of the second embodiment in FIG. 4A and FIG. 4B. As shown in FIG. 5, the display device receives display data of three pixels P1, P2 and P3 in a first original frame F1. Values of sub-pixels (R, G, B) of pixels P1, P2 and P3 are (64, 16, 150), (8, 255, 1), (2, 4, 8) respectively. It is assumed that a first threshold value is 32 and a second threshold value is 4, meaning the first interval is 32-255, the second interval is 4-31, and the third interval is 0-3.

In a first frame duration F1a of the first original frame F1, the backlight displays 100% backlight brightness, and the display circuit outputs all display data categorized in the first original display data group. Therefore, values of sub-pixels (R, G, B) of pixels P1, P2 and P3 are (64, 0, 150), (0, 255, 0), (0, 0, 0) respectively in the first frame duration F1a.

In a second frame duration F1b of the first original frame F1, the backlight adjusts the backlight brightness according to a first parameter G1 (e.g. G1=8) and displays 12.5% backlight brightness (i.e. 100%/8=12.5%). The display circuit multiplies all display data categorized in the second original display data group by the first parameter G1 and outputs the multiplied display data. Therefore, values of sub-pixels (R, G, B) of pixels P1, P2 and P3 are (0, 128, 0), (64, 0, 0), (0, 32, 64) respectively in the second frame duration F1b.

In a third frame duration F1c of the first original frame F1, the display circuit multiplies all display data categorized in the third original display data group by a product of the first and second parameters G1, G2 (e.g. G2=8) and outputs the multiplied display data. The backlight adjusts the backlight brightness according to the product of the first and second parameters G1, G2 and outputs 1.56% (100%/[8*8]=1.56%) backlight brightness. Therefore, values of sub-pixels (R, G, B) of pixels P1, P2 and P3 are (0, 0, 0), (0, 0, 64), (128, 0, 0) respectively in the third frame duration F1c.

Each of the first, second and third frame durations F1a, F1b and F1c occupies one third of the first original frame F1. Generally, frame rate of a LCD panel is 60 Hz, so duration of the first original frame F1 is approximately 16 milliseconds, meaning each of the first, second and third frame durations F1a, F1b and F1c is approximately 5.33 milliseconds respectively.

The present invention further discloses a method for controlling a first color backlight and a second color backlight of a display circuit of a display device. The method comprises:

receiving a plurality of first display data groups for driving a plurality of first color display units of the first color backlight of the first backlight by the display circuit;

categorizing the first display data groups into first color first original display data of a first interval and first color second original display data of a second interval, numerical values of the first color first original display data being larger than or equal to a first threshold value, and numerical values of the first color second original display data being smaller than the first threshold value;

receiving a plurality of second display data groups for driving a plurality of first color display units of the second backlight by the display circuit;

categorizing the second display data groups into second color first original display data of a third interval and second color second original display data of a fourth interval, numerical values of the second color first original display data being greater than or equal to a second threshold value, and numerical values of the second color second original display data being smaller than the second threshold value;

the display circuit outputting the first color first original display data in a first frame duration F1a;

the first color backlight outputting a first brightness W1 in the first frame duration F1a and sustaining the first brightness W1 for a first lighting duration T1;

adjusting the first color second original display data for generating first color second adjusted display data according to a first parameter Gr, light transmittance corresponding to the first color second adjusted display data being higher than light transmittance corresponding to the first color second original display data;

the display circuit outputting the first color second adjusted display data in a second frame duration F1b;

adjusting the first brightness W1 for generating a second brightness W2 according to the first parameter Gr, and adjusting the first lighting duration T1 to generate a second lighting duration T2, a product of the second brightness W2 and the second lighting duration T2 being smaller than a product of the first brightness W1 and the first lighting duration T1;

the first color backlight outputting the second brightness W2 in the second frame duration F1b and sustaining the second brightness W2 for the second lighting duration T2;

the display circuit outputting the second color first original display data in a third frame duration F1c;

the second color backlight outputting a third brightness W3 in the third frame duration F1c and sustaining the third brightness W3 for a third lighting duration T3;

adjusting the second color second original display data for generating second color second adjusted display data according to a second parameter Gg, light transmittance corresponding to the second color second adjusted display data being higher than light transmittance corresponding to the second color second original display data;

the display circuit outputting the second color second adjusted display data in a fourth frame duration F1d;

adjusting the third brightness W3 for generating a fourth brightness W4 according to the second parameter Gg, and adjusting the third lighting duration T3 to generate a fourth lighting duration T4, a product of the fourth brightness W4 and the fourth lighting duration T4 being smaller than a product of the third brightness W3 and the third lighting duration T3;

the second color backlight outputting the fourth brightness in the fourth frame duration F1d and sustaining the fourth brightness W4 for the fourth lighting duration T4.

In the present embodiment, the first parameter Gr=(the first brightness W1/the second brightness W2)*(the first lighting duration T1/the second lighting duration T2). The first color second original display data is M bits long, which varies in a range of 0 to 2^{M}−1, the first parameter Gr is 2^{N}, and the first threshold value is 2^{M-N}. For instance, if the first color second original display data is 8 bits, values of the first color second original display data vary in a range of 0 to 255, the first parameter Gr is 4 and the first threshold value is 64.

The second parameter Gg=(the third brightness W3/the fourth brightness W4)*(the third lighting duration T3/the fourth lighting duration T4). The second color second original display data is M bits long, which varies in a range of 2^{m}−1, the second parameter Gg is 2^{N}, and the second threshold value is 2^{M-N}. For instance, the second color first original display data and the second color second original display data are both 8 bits, where values of the second color first original display data vary in a range of 32 to 255, values of the second color second original display data vary in a range of 0 to 31, the second parameter Gg is 8, and the second threshold value is 32.

Furthermore, in the present embodiment, the first color is red and the second color is green. The first color backlight is a red light LED (Light Emitting Diode) which outputs red light in the first and second frame durations. The second color backlight is a green light LED which outputs green light in the third and fourth frame durations.

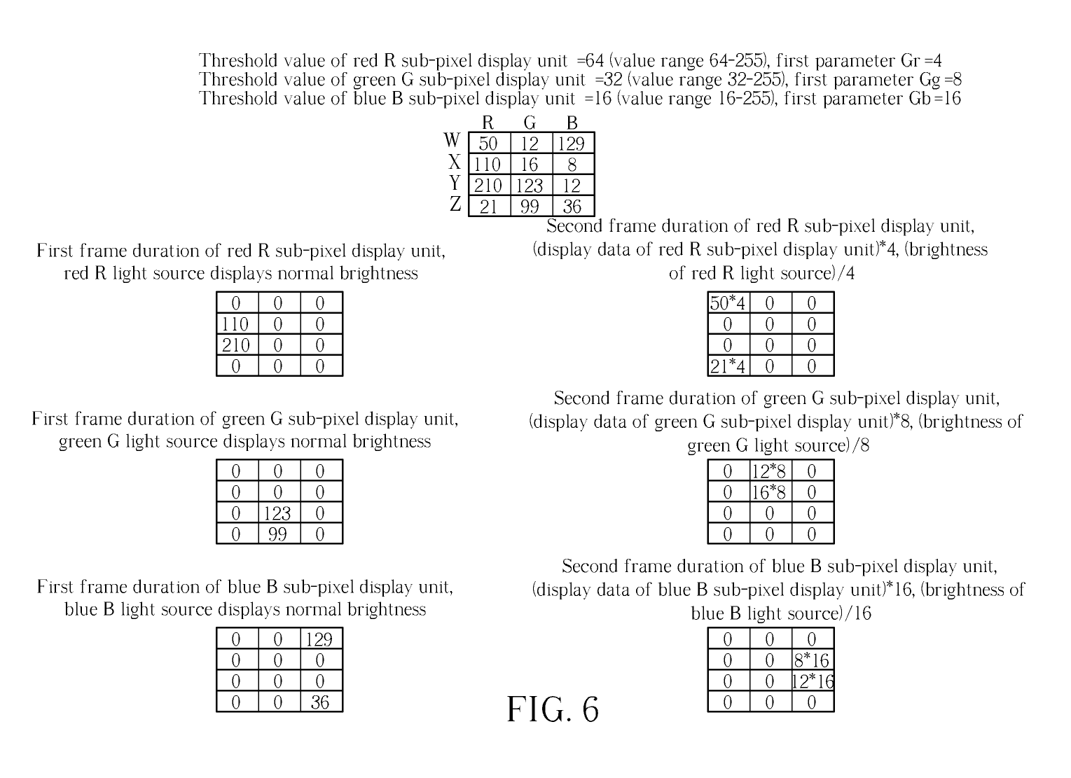

Please refer to FIG. 6. FIG. 6 is a diagram illustrating a third embodiment of the method of the present invention for controlling a display circuit and backlight of a display device. In the third embodiment, the method of the present invention is utilized to control an LCD device with a tricolor backlight device, where each of (R, G, B) sub-pixels of the LCD device utilizes a different threshold value to adjust the corresponding display data and backlight. Taking pixels W, X, Y, Z of the display panel as shown in FIG. 6 as an example, each pixel comprises a red R sub-pixel display unit, a green G sub-pixel display unit and a blue B sub-pixel display unit. For instance, display data of (R, G, B) sub-pixel display units of pixel W are (50, 12, 129); display data of (R, G, B) sub-pixel display units of pixel X are (110, 16, 8); display data of (R, G, B) sub-pixel display units of pixel Y are (210, 123, 12); and display data of (R, G, B) sub-pixel display units of pixel Z are (21, 99, 36).

A threshold value for the red R sub-pixel display unit is 64 (e.g. corresponds to an interval of 64-255), a threshold value for the green G sub-pixel display unit is 32 (e.g. corresponds to an interval of 32-255), and a threshold value for the blue B sub-pixel display unit is 16 (e.g. corresponds to an interval of 16-255). In other words, the first parameter Gr of the red R sub-pixel display unit is 4, the second parameter Gg of the green G sub-pixel display unit is 8, and the third parameter Gb of the blue B sub-pixel display unit is 16.

The display panel outputs display data of the red R sub-pixel display unit which falls in the interval of 64-255 in a first frame duration of the red R sub-pixel display unit, and the red R light source displays normal brightness (e.g. 100% brightness) for (R, G, B) sub-pixel display units of pixels W, X, Y, Z to output display data of (0, 0, 0), (110, 0, 0), (210, 0, 0), (0, 0, 0) respectively. Ina second frame duration of the red R sub-pixel display unit, display data of the red R sub-pixel display unit which falls in the interval of 0-63 is multiplied by the first parameter Gr, and the brightness output by the red R light source is divided by the first parameter Gr accordingly. The display panel outputs display data of the red R sub-pixel display unit in the interval of 0-63, so (R, G, B) sub-pixel display units of pixels W, X, Y, Z output display data of (50*4, 0, 0), (0, 0, 0), (0, 0, 0), (21*4, 0, 0) respectively.

The display panel outputs display data of the green G sub-pixel display unit which falls in the interval of 32-255 in a first frame duration of the green G sub-pixel display unit, and the green G light source displays normal brightness for (R, G, B) sub-pixel display units of pixels W, X, Y, Z to output display data of (0, 0, 0), (0, 0, 0), (0, 123, 0), (0, 99, 0) respectively. Ina second frame duration of the green G sub-pixel display unit, display data of the green G sub-pixel display unit which falls in the interval of 0-31 is multiplied by the second parameter Gg, and brightness outputted by the green G light source is divided by the second parameter Gg accordingly. The display panel outputs display data of the green G sub-pixel display unit in the interval of 0-31, so (R, G, B) sub-pixel display units of pixels W, X, Y, Z output display data of (0, 12*8, 0), (0, 16*8, 0), (0, 0, 0), (0, 0, 0) respectively.

The display panel outputs display data of the blue B sub-pixel display unit which falls in the interval of 16-255 in a first frame duration of the blue B sub-pixel display unit, and the blue B light source displays normal brightness for (R, G, B) sub-pixel display units of pixels W, X, Y, Z to output display data of (0, 0, 129), (0, 0, 0), (0, 0, 0), (0, 0, 36) respectively. In a second frame duration of the blue B sub-pixel display unit, display data of the blue B sub-pixel display unit which falls in the interval of 0-15 is multiplied by the third parameter Gb, and brightness outputted by the blue B light source is divided by the third parameter Gb accordingly. The display panel outputs display data of the blue B sub-pixel display unit in the interval of 0-15, so (R, G, B) sub-pixel display units of pixels W, X, Y, Z output display data of (0, 0, 0), (0, 0, 8*16), (0, 0, 12*16), (0, 0, 0) respectively.

This way, the first and second frame durations of the red R sub-pixel display unit, the first and second frame durations of the green G sub-pixel display unit, and the first and second frame durations of the blue B sub-pixel display unit can be driven once in any order within one frame period (e.g. 16 milliseconds) of the LCD device.

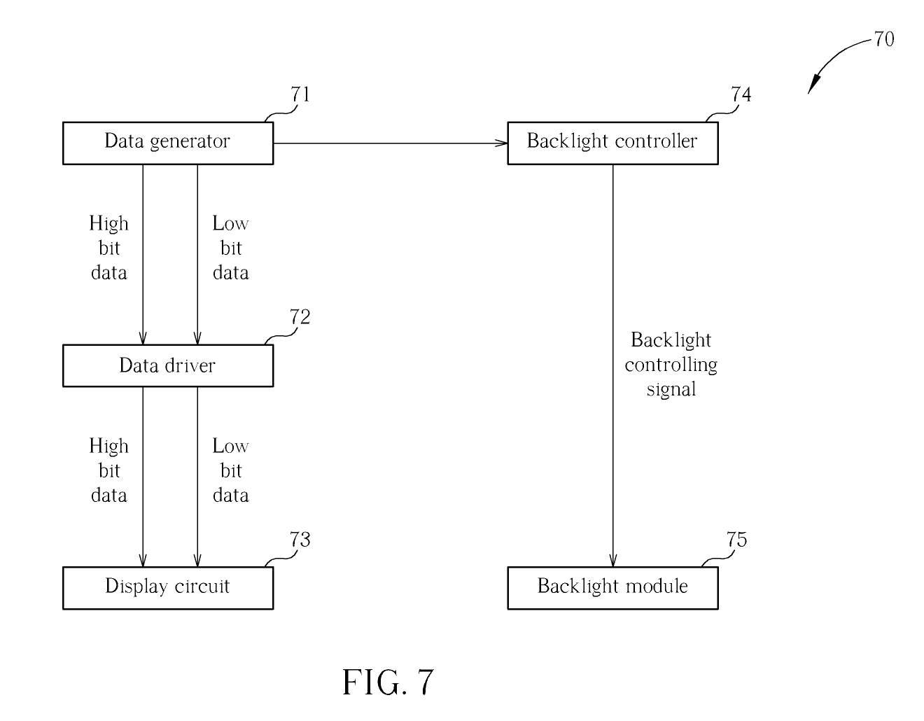

Please refer to FIG. 7. FIG. 7 is a diagram illustrating a control device 70 of the present invention. The control device 70 comprises a data generator 71, a data driver 72, a display circuit 73, a backlight controller 74 and a backlight module 75. The data generator 71 is for categorizing display data into different original display data groups according to predetermined interval. The data driver 72 is coupled to the data generator 71, for adjusting different original display data groups according to predetermined parameters (e.g. first parameter G1, second parameter G2, etc. in the above embodiments), and outputting adjusted display data of the original display data groups in different frame durations in one video frame. The display circuit 73 is coupled to the data driver 72, for displaying the display data output by the data driver 72. The backlight controller 74 is coupled to the data generator 71, for generating backlight controlling signals corresponding to different frame durations in the video frame. The backlight module 75 is coupled to the backlight controller 74, for generating backlight brightness and sustaining the backlight brightness for a lighting duration. The backlight module 75 generates different backlight brightnesses and sustains the different backlight brightnesses for different lighting durations according to the backlight controlling signal.

In conclusion, the method for controlling a display circuit and backlight of a display device of the present invention utilizes predetermined interval to categorize display data of display units into different original display data groups, then adjusts display data of different original display data groups according to a predetermined parameter, and adjusts the backlight brightness or lighting duration of the backlight accordingly. Therefore, the nonlinear color temperature curve of the display device can be reduced to distribution in display data of even lower grey scales, so curvature of the color temperature curve appears flatter, improving display quality of the display device.

Those skilled in the art will readily observe that numerous modifications and alterations of the device and method may be made while retaining the teachings of the invention.

What is claimed is:

1. A method for controlling a display circuit and a backlight of a display device, the method comprising:
receiving a plurality of display data groups for driving a plurality of display units of same color within the backlight by the display circuit;
categorizing the display data groups into a first original display data in a first interval and a second original display data in a second interval, wherein numerical values in the first original display data are larger than or equal to a threshold value, and the other numerical values in the second original display data are smaller than the threshold value;
outputting the first original display data in a first frame duration by the display circuit;
outputting a first brightness in the first frame duration and sustaining the first brightness for a first lighting duration by the backlight;
adjusting the second original display data for generating second adjusted display data according to a first parameter G1, wherein light transmittance corresponding to the second adjusted display data is higher than light transmittance corresponding to the second original display data;
outputting the second adjusted display data in a second frame duration by the display circuit; and
adjusting output of the backlight of the display device according to the first parameter G1 in the second frame duration.

2. The method of claim 1, wherein the step of adjusting output of the backlight of the display device according to the first parameter G1 in the second frame duration comprises:
reducing the first brightness for generating a second brightness according to the first parameter G1; and
outputting the second brightness in the second frame duration and sustaining the second brightness for the first lighting duration by the backlight.

3. The method of claim 1, wherein the step of adjusting output of the backlight of the display device according to the first parameter G1 in the second frame duration comprises:
reducing the first lighting duration for generating a second lighting duration according to the first parameter G1; and
outputting the first brightness in the second frame duration and sustaining the first brightness for the second lighting duration by the backlight.

4. The method of claim 1, wherein the step of adjusting output of the backlight of the display device according to the first parameter G1 in the second frame duration comprises:
adjusting the first lighting duration for generating a second lighting duration according to the first parameter G1, and adjusting the first brightness for generating a second brightness according to the first parameter G1, a product of the second brightness and the second lighting duration being smaller than a product of the first brightness and the first lighting duration; and
outputting the second brightness in the second frame duration and sustaining the second brightness for the second lighting duration by the backlight.

5. The method of claim 4, wherein the first lighting duration is divided by X for generating the second lighting duration, the first brightness is divided by Y for generating the second brightness, and the first parameter G1=X*Y.

6. The method of claim 1, wherein the second original display data is multiplied by the first parameter G1 for generating the second adjusted display data, light transmittance corresponding to the second adjusted display data is G1 times the light transmittance corresponding to the second original display data, and the first brightness is divided by the first parameter G1 for generating the second brightness.

7. The method of claim 6, wherein the second original display data is M bits, the first parameter G1 is 2^{N}, and the threshold value is 2^{M-N}.

8. The method of claim 7, wherein the second original display data is 8 bits, the first parameter G1 is 8 and the threshold value is 32.

9. A method of controlling a display circuit and a backlight of a display device, the method comprising:
receiving a plurality of display data groups for driving a plurality of display units of same color within the backlight by the display circuit;
categorizing the display data groups into first original display data in a first interval, second original display data in a second interval, and third original display data in a third interval, wherein numerical values of the first original display data are larger than or equal to a first threshold value, numerical values of the second original display data are smaller than the first threshold value and larger than or equal to a second threshold value, and numerical values of the third original display data are smaller than the second threshold value;
outputting the first original display data in a first frame duration by the display circuit;
outputting a first brightness in the first frame duration and sustaining the first brightness for a first lighting duration by the backlight;
adjusting the second original display data for generating second adjusted display data according to a first parameter G1;
outputting the second adjusted display data in a second frame duration by the display circuit;
adjusting the first lighting duration for generating a second lighting duration according to the first parameter G1, and adjusting the first brightness for generating a second brightness, wherein a product of the second brightness and the second lighting duration is smaller than a product of the first brightness and the first lighting duration;
outputting the second brightness in the second frame duration and sustaining the second brightness for the second lighting duration by the backlight;
adjusting the third original display data for generating third adjusted display data according to the first parameter G1 and a second parameter G2;
outputting the third adjusted display data in a third frame duration by the display circuit;
adjusting the second brightness for generating a third brightness according to the second parameter G2, and adjusting the second lighting duration for generating a third lighting duration, wherein a product of the third brightness and the third lighting duration is smaller than a product of the second brightness and the second lighting duration; and
outputting the third brightness in the third frame duration and sustaining the third brightness for the third lighting duration by the backlight.

10. The method of claim 9, wherein the first parameter G1=(the first brightness/the second brightness)*(the first lighting duration/the second lighting duration).

11. The method of claim 10, wherein the first parameter G1=8, (the first brightness/the second brightness)=4, and (the first lighting duration/the second lighting duration)=2.

12. The method of claim 9, wherein the second parameter G2=(the second brightness/the third brightness)*(the second lighting duration/the third lighting duration).

13. The method of claim 12, wherein the second parameter G2=8, (the second brightness/the third brightness)=8, and (the second lighting duration/the third lighting duration)=1.

14. A method for controlling a first color backlight and a second color backlight of a display circuit of a display device, the method comprising:
receiving a plurality of first display data groups for driving a plurality of display units of the first color backlight by the display circuit;
categorizing the first display data groups into first color first original display data in a first interval and first color second original display data in a second interval, wherein numerical values of the first color first original display data are larger than or equal to a first threshold value, and numerical values of the first color second original display data are smaller than the first threshold value;
receiving a plurality of second display data groups for driving a plurality of display units of the second color backlight by the display circuit;
categorizing the second display data groups into second color first original display data in a third interval and second color second original display data in a fourth interval, wherein numerical values of the second color first original display data are greater than or equal to a second threshold value, and numerical values of the second color second original display data are smaller than the second threshold value;
outputting the first color first original display data in a first frame duration by the display circuit;
outputting a first brightness in the first frame duration and sustaining the first brightness for a first lighting duration by the first color backlight;
adjusting the first color second original display data for generating first color second adjusted display data according to a first parameter G1, wherein light transmittance corresponding to the first color second adjusted display data is higher than light transmittance corresponding to the first color second original display data;
outputting the first color second adjusted display data in a second frame duration by the display circuit;
adjusting the first brightness for generating a second brightness according to the first parameter G1, and adjusting the first lighting duration to generate a second lighting duration, wherein a product of the second brightness and the second lighting duration is smaller than a product of the first brightness and the first lighting duration;
outputting the second brightness in the second frame duration and sustaining the second brightness for the second lighting duration by the first color backlight;
outputting the second color first original display data in a third frame duration by the display circuit;
outputting a third brightness in the third frame duration and sustaining the third brightness for a third lighting duration by the second color backlight;
adjusting the second color second original display data for generating second color second adjusted display data according to a second parameter G2, wherein light transmittance corresponding to the second color second adjusted display data is higher than light transmittance corresponding to the second color second original display data;
outputting the second color second adjusted display data in a fourth frame duration by the display circuit;
adjusting the third brightness for generating a fourth brightness according to the second parameter G2, and adjusting the third lighting duration for generating a fourth lighting duration, wherein a product of the fourth brightness and the fourth lighting duration is smaller than a product of the third brightness and the third lighting duration; and
outputting the fourth brightness in the fourth frame duration and sustaining the fourth brightness for the fourth lighting duration by the second color backlight.

15. The method of claim 14, wherein the first parameter G1=(the first brightness/the second brightness)*(the first lighting duration/the second lighting duration).

16. The method of claim 14, wherein the first color second original display data is M bits, the first parameter G1 is 2^{N}, and the first threshold value is 2^{M-N}.

17. The method of claim 16, wherein the first color second original display data is 8 bits, the first parameter G1 is 4 and the first threshold value is 64.

18. The method of claim 14, wherein the second parameter G2=(the third brightness/the fourth brightness)*(the third lighting duration/the fourth lighting duration).

19. The method of claim 14, wherein the second color second original display data is M bits, the second parameter G2 is 2^{N} and the second threshold value is 2^{M-N}.

20. The method of claim 19, wherein the second color second original display data is 8 bits, the second parameter G2 is 8 and the second threshold value is 32.

21. The method of claim 14, where a first color is red, a second color is green, the first color backlight is a red light LED which outputs red light in the first and second frame durations, and the second color backlight is a green light LED which outputs green light in the third and fourth frame durations.
